(19) United States
(12) Patent Application Publication
(10) Pub. No.: US 2016/0354268 A1
(43) Pub. Date: Dec. 8, 2016

(54) PORTABLE MALE URINAL

(71) Applicant: Eric Fennell, Compton, CA (US)

(72) Inventor: Eric Fennell, Compton, CA (US)

(21) Appl. No.: 14/730,302

(22) Filed: Jun. 4, 2015

(51) Int. Cl. A61G 9/00

(52) U.S. Cl. CPC A61G 9/006

(57) ABSTRACT

A portable male urinal is provided which consists of a portable retention container for holding urine therein. The portable male urinal includes a combination urinal cup and elongated flexible tube used for channeling the flow of urine discharged from a body of a person directly into the portable retention container. An adjustable stanchion is provided for suspending the combination urinal cup and flexible tube above the portable retention container. The elongated flexible tube easily attaches and detaches itself from both the urine cup and the portable retention container in use and for cleaning purposes. Also, a flip lid is provided with the urine cup for containing odors during nonuse.

### FIELD OF THE INVENTION

The present invention relates generally to portable urinals, and more specifically, to a portable male urinal having an adjustable cup which directs urine to flow into a container.

### BACKGROUND OF THE INVENTION

Portable urinals are used by those who need to urinate but cannot access a toilet, for example, patients confined to a bed. Typically, such urinals include a urine receiving reservoir and a spout extending therefrom. The spout includes an inlet through which the urine is received and typically contains a valve structured to resist backflow.

Overflow and backflow are long recognized problems associated with handheld portable urinals. Overflow and backflow, or undesirable spillage, of urine may occur during multiple uses while filling and handling portable urinals. Overflow and backflow may be caused by urine escaping out of the reservoir when it is over capacitated or overfilled. A problem arises in that overflow and backflow results in the urine coming into contact with the patient handling the portable urinal or in the patient's bed causing unsanitary health conditions increasing risk for further medical problems, such as infections. In addition, the workload of caretakers is increased due to the need for cleaning the patient and/or the bed following the spillage of urine thereon. Mishandling of the urinal may be a result of the bedridden patient leaving the urinal, for example, on the bed following use and then inadvertently contacting the urinal and causing spillage therefrom.

Many prior art attempts have been made to address the above problems. One such prior art attempt to prevent backflow discloses a portable handheld urinal having a valve assembly, U.S. Pat. No. 7,846,143, entitled “Portable urinal with a shaped inlet and a membrane valve” and teaches of a portable urinal that includes a container defining a liquid reservoir and a spout extending therefrom. The spout has an inlet for receiving a liquid. A valve assembly is disposed within the spout. The valve assembly has an interior region and an exterior region. The valve assembly includes a sidewall and one or more sealable openings for permitting flow of a liquid into the reservoir, while resisting undesired flow of the liquid out of the reservoir. However, the reservoir taught by this patent has a small volume and cannot be used for multiple uses by the patient.

Another, prior art attempt to prevent overflow is taught by U.S. Pat. No. 8,181,284 entitled “Mobile sanitary urinal and method of use thereof” which discloses a mobile sanitary urinal apparatus for truck drivers or others who do not have access to restroom facilities while traveling. The urinal comprises a catheter-type receiver which attaches to plumbing thereby functioning as a urinal to receive urine from a user and directing it through a hose to a retention container. The retention container would be emptied into a sanitary collection station or normal restroom when feasible.

However, the techniques or apparatus disclosed above in the prior art suffer from one or more disadvantages in emptying urine, such as the handheld urinal utilizes a reservoir having a small volume and cannot be used by the patient urinating multiple times without them having to get up and empty their urinal. Also, the mobile sanitary urinal has the plumbing permanently connected to the retention container and houses an emptying orifice located at the top of the retention container wherein both of these features may make this portable urinal difficult and cumbersome to empty without splashing urine on the person emptying the container.

In view of the aforesaid problems, it is understood that there exists a need for a new and improved portable male urinal that may be used multiple times, is easy to use, empty and keep clean. The present invention solves this and other problems in a unique and novel fashion.

### SUMMARY OF THE INVENTION

A portable male urinal is provided which consists of a portable retention container for holding urine therein. The portable male urinal includes a combination urinal cup and elongated flexible tube used for channeling the flow of urine discharged from a body of a person directly into the portable retention container. An adjustable stanchion is provided for suspending the combination urinal cup and flexible tube above the portable retention container. The elongated flexible tube easily attaches and detaches itself from both the urine cup and the portable retention container in use and for cleaning purposes.

Another objective of the current invention is to provide a flip lid with the urine cup for containing odors during nonuse.

Certain embodiments of the current invention, but are not limited to, is to provide a portable male urinal which may be easily disassembled for allowing the safe release of urine from the portable retention container.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a perspective view of the portable urinal device of the present invention; and

FIG. 2 is a perspective view of the portable urinal device shown in FIG. 1 for use in urinating.

FIG. 3 is a perspective view of the portable urinal device configured for emptying urine.

### DETAIL DESCRIPTION OF THE INVENTION

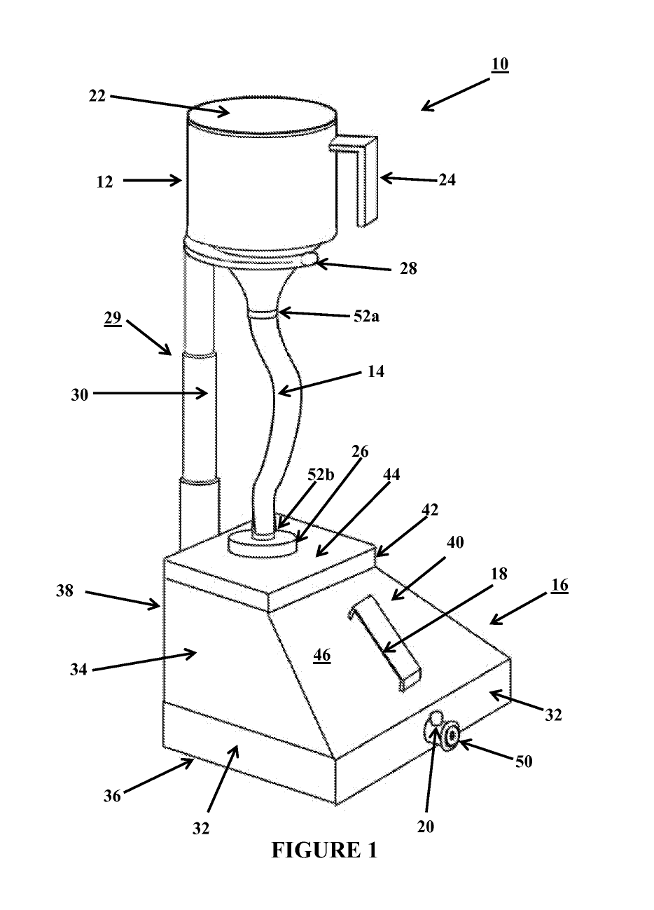

Referring now to FIG. 1, there is shown a male portable urinal 10 in accordance with the present invention. The male portable urinal 10 consists of a combination urine cup 12 and elongated flexible hose 14 for channeling the flow of urine discharged from a body of a person (not shown) into a portable retention container 16 for holding urine therein. An adjustable stanchion 30 is provided for suspending the urine cup and flex hose combination, 12 and 14 respectively above portable retention container 16 and whose height is set by a patient (not shown) for ease of use. The elongated flexible hose 14 is sized in both length and diameter for fluidly connecting the urine cup 12 to the portable retention container 16, so that the urine discharged from the body of the person all goes directly into the portable retention container 16 by the force of gravity there between, preventing unwanted splashing during urination.

Turning once again to FIG. 1, in one preferred embodiment the portable retention container 16 comprises a rectangular shaped or pedestal bottom portion 32 having bottom wall 36, upstanding side walls 34 on opposite sides, a rear wall 38, a slanted front wall 40, a rectangular shaped or pedestal top portion 42 and a top wall 44, so as to form a chamber 46 for holding the urine therein. A release valve 20 is provided and attached to the front of the rectangular shaped bottom portion 32 of the container 16 with the release valve 20 having an orifice for emptying the urine out of the chamber 46 when full, while a snap on cap 50 is for covering the orifice of the release valve 20.

A container connector 26 is disposed on the top wall 44 of the container 16, so that a lower end of the elongated flexible tube 14 may be attached to and/or detached from the connector 26. In a preferred embodiment, container connector 26 defines a short rigid hose fitting 52b having a smaller diameter than the elongated flexible tube 14 such that flex tube 14 may be slipped on for urination and pulled off from the short rigid hose fitting 52b of container connector 26 when emptying the portable retention container 16. In another preferred embodiment, the end of the elongated flexible tube 14 may be secured to container connector 26 by a threaded attachment thereby allowing the elongated flexible tube 14 to be screwed on or screwed off from container connector 26.

The urine cup 22 defines a tapered bottom 48 which also ends in another short hose fitting 52a which has a slightly smaller diameter than the elongated flexible tube 14 such that the top of flex tube 14 may be snugly slipped on for urination and pulled off and away from the short rigid hose fitting 52a of the urine cup 22 for cleaning purposes. In another preferred embodiment, the top end of the elongated flexible tube 14 may be secured to the bottom of urine cup 22 by a threaded attachment thereby allowing the elongated flexible tube 14 to be screwed on or screwed off from urine cup 22.

The stanchion 30 is height adjustable and includes an elongated telescopic rod 29 mounted and affixed to the rear wall 38 of the portable retention container 16 and is similar if not identical in design and construction as that of the known prior art of telescopic rods used with luggage handles. Secured to the top of the stanchion 30 is a horseshoe shaped holder 28 sized to receive the tapered bottom 24 for holding the urine cup when not in use, as shown in FIG. 1. Additionally, the urine cup includes a cup handle 48 and cup lid 22. A container handle 18 extends from the slanted front wall 40, so that the portable retention container 16 may be carried by the container handle 18.

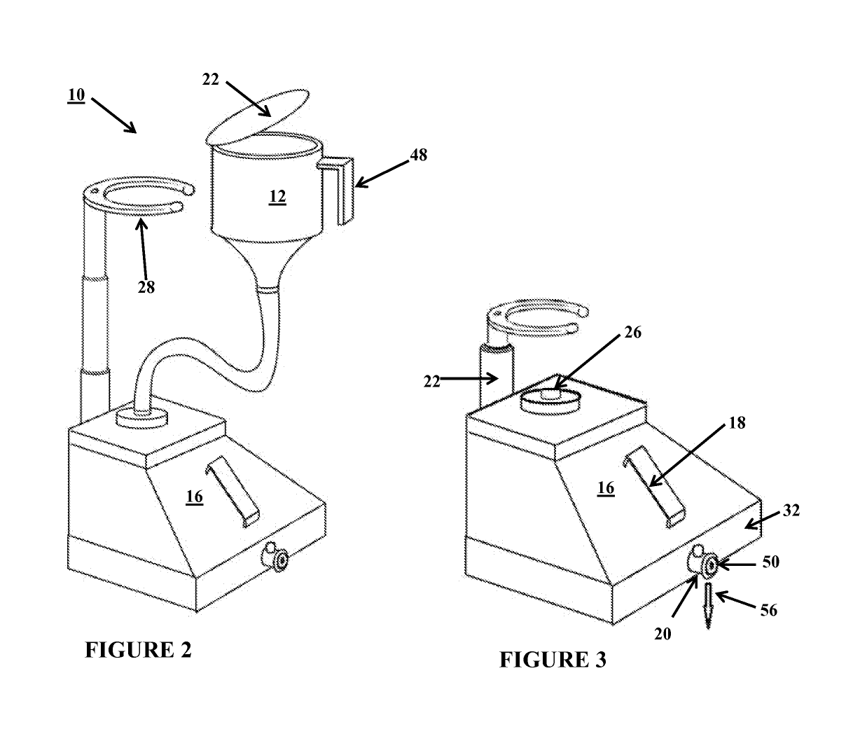

Referring now to FIG. 2, in use, the portable male urinal device 10 is lifted off the horseshoe shaped holder 28 using cup handle 48 wherein the cup lid 22 is flipped open and the person urinates into urine cup 22 such that the urine discharged from the body of the person all goes directly into the portable retention container 16 by the force of gravity there between. In accordance with the present invention, male portable urinal 10 may be used by person or the aged in a wheelchair or on a bed. Although, the portable retention container 16 is shown box shaped, it may be round or any other shape and therefore is not limited to the configuration shown in the drawings. The portable retention container 16 may also be fabricated out of any type of durable material and can come in different sizes and thicknesses. Lastly, the flip lid 22 is provided with the urine cup is closed for containing odors during nonuse

Referring now to FIG. 3, when after multiple uses the portable retention container 16 gets filled the elongated flexible tube is detached and removed with the urinal cup and the elongated telescopic rod 29 is placed in the closed or stowed position. The portable retention container 16 can now be transported using container handle 18 to a place where the urine can be released 56 using release valve 20 by flipping open cap 50. The release valve 20 may be located anywhere on the container 16, but preferably to the front of the rectangular shaped bottom portion 32. Additionally, container connector 26 acts as a pressure relief valve thereby allowing the urine to evacuate 56 quickly through release valve 20.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

What is claimed is:

1. A male portable urinal, comprising:
a urine cup having a handle and a lid for opening and closing;
an elongated flexible tube connected at a top end to a bottom of said urinal cup;
a portable retention container connected to a bottom end of said elongated flexible tube and said elongated flexible tube being able to quickly attach and detach from either or both said urine cup and said elongated flexible tube, wherein
said combination of said urine cup and elongated flexible tube allows discharged urine to go directly using force of gravity into said portable retention container multiple times and said portable retention container having a release valve located as to prevent splashing during evacuation of urine.

2. The male portable urinal according to claim 1, wherein said portable retention container includes a height adjustable stanchion for holding during nonuse said urine cup and said elongated flexible tube above said portable retention container.

3. The male portable urinal according to claim 2, wherein said stanchion is height adjustable through the use of an elongated telescopic rod.

4. The male portable urinal according to claim 2, wherein said stanchion uses a horseshoe shaped holder for holding during nonuse said urine cup and said elongated flexible tube

5. The male portable urinal according to claim 1, further including:
a container valve located at a top of said portable retention container that allows attaches to said bottom of said elongated flexible tube for use during urination and detaches from said container valve thereby allowing said container valve to provide pressure relief during evacuation of urine from said portable retention container.
